(19) United States
(12) Patent Application Publication
(10) Pub. No.: US 2007/0045064 A1
(43) Pub. Date: Mar. 1, 2007

(54) Mass reduction for twin piston calipers

(75) Inventor: Philip N. Jedele, Ypsilanti, MI (US)

Correspondence Address: HARNESS, DICKEY & PIERCE, P.L.C., P.O. BOX 828, BLOOMFIELD HILLS, MI, 48303, US

(73) Assignee: Akebono Corporation (North America)

(21) Appl. No.: 11/211,368

(22) Filed: Aug. 25, 2005

(51) Int. Cl. F16D 65/00

(52) U.S. Cl. 188/73.39; 188/73.1

(57) ABSTRACT

A disc brake includes a support bracket, slide pins coupled to the support bracket, inner and outer brake shoes and a caliper moveably supported by the slide pins. The caliper has first and second spaced apart piston cavities positioned along a longitudinally extending rail, a plurality of spaced apart fingers positioned opposite the rail and a laterally extending bridge interconnecting the rail and the fingers. The bridge includes spaced apart and substantially parallel bridge portions. The rail includes a recess extending from a side of the rail including openings to the piston cavities.

### BACKGROUND AND SUMMARY OF THE INVENTION

The present invention relates to a brake and, more particularly, to a disc brake having a slidable twin piston caliper.

Automotive vehicle design has become very challenging in recent years. Market forces dictate that the manufacturers of automotive components reduce component cost and component weight while improving vehicle system performance and durability. Typically, reduced mass components are desirable anywhere in the vehicle and are particularly beneficial where the mass is un-sprung. Un-sprung mass exists at the wheel ends and includes components such as the wheels, the tires, the brakes, and the knuckle or spindle.

Many manufacturers have attempted to balance the need for lower cost, lower weight components with stringent structural and operational specifications. While some of these manufacturers have made progress toward meeting these goals, room for improvement exists.

Accordingly, a disc brake is provided having a support bracket, slide pins coupled to the support bracket, inner and outer brake shoes, and a caliper moveably supported by the slide pins. The caliper has first and second spaced apart piston cavities positioned along a longitudinally extending rail, a plurality of spaced apart fingers positioned opposite the rail and a laterally extending bridge interconnecting the rail and the fingers. The bridge includes spaced apart substantially parallel bridge portions. This configuration provides a reduced mass between the piston caliper. Other embodiments having various weight-reducing features such as pockets and apertures are also disclosed.

### BRIEF DESCRIPTION OF THE DRAWINGS

The present invention will become more fully understood from the detailed description and the accompanying drawings, wherein:

FIG. 1 is an exploded perspective view of an exemplary disc brake constructed in accordance with the teachings of the present invention;

FIG. 2 is a perspective view of the assembled disc brake without the disc;

FIG. 3 is a perspective view of the assembled disc brake taken from another view;

FIG. 4 is a schematic depicting the radial locations of the piston bores, the slide pin apertures and the brake support apertures;

FIG. 5 is a perspective view of the brake caliper of the disc brake shown in FIG. 1;

FIG. 6 is an end view of the disc brake caliper shown in FIG. 5;

FIG. 7 is a cross-sectional view taken along line 7-7 shown in FIG. 6;

FIG. 8 is a perspective view of an alternate embodiment disc brake caliper;

FIG. 9 is a perspective view of the disc brake caliper of FIG. 8 taken from another angle;

FIG. 10 is a perspective view of another alternate embodiment disc brake caliper;

FIG. 11 is a perspective view of another alternate embodiment disc brake caliper; and

FIG. 12 is a perspective view of another alternate embodiment disc brake caliper.

### DETAILED DESCRIPTION OF THE PREFERRED EMBODIMENTS

The following description of the preferred embodiment(s) is merely exemplary in nature and is in no way intended to limit the invention, its application, or uses.

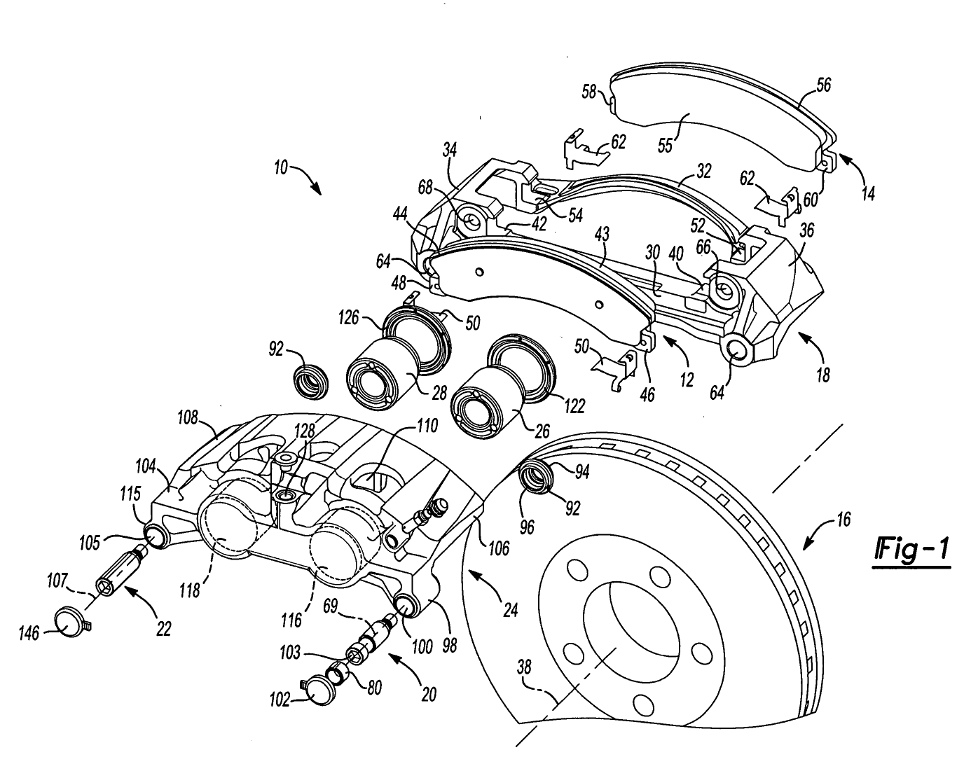

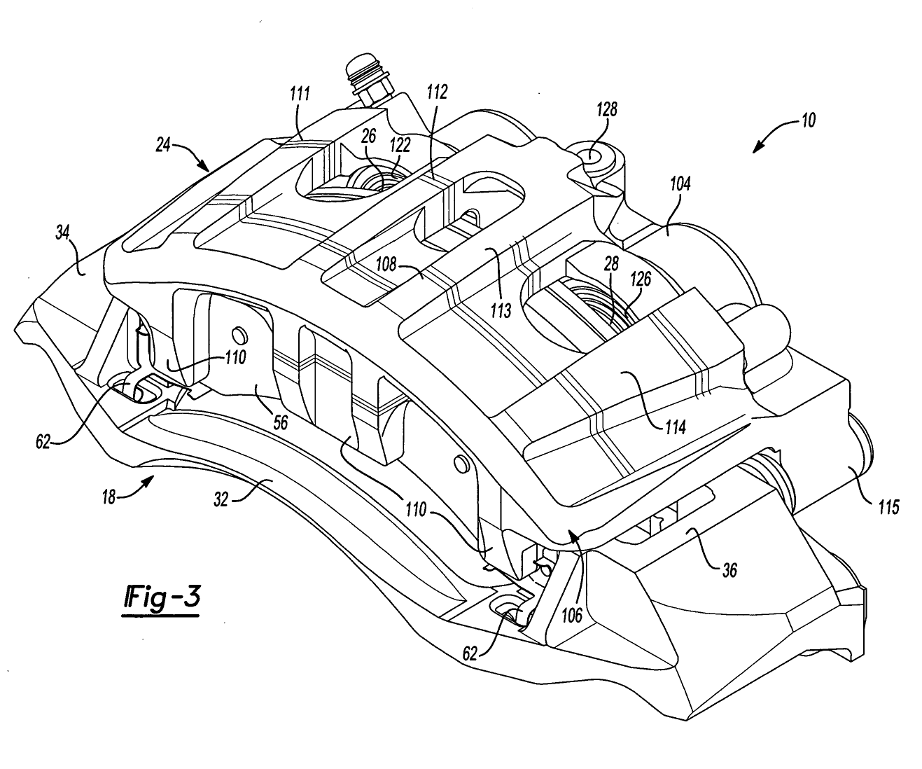

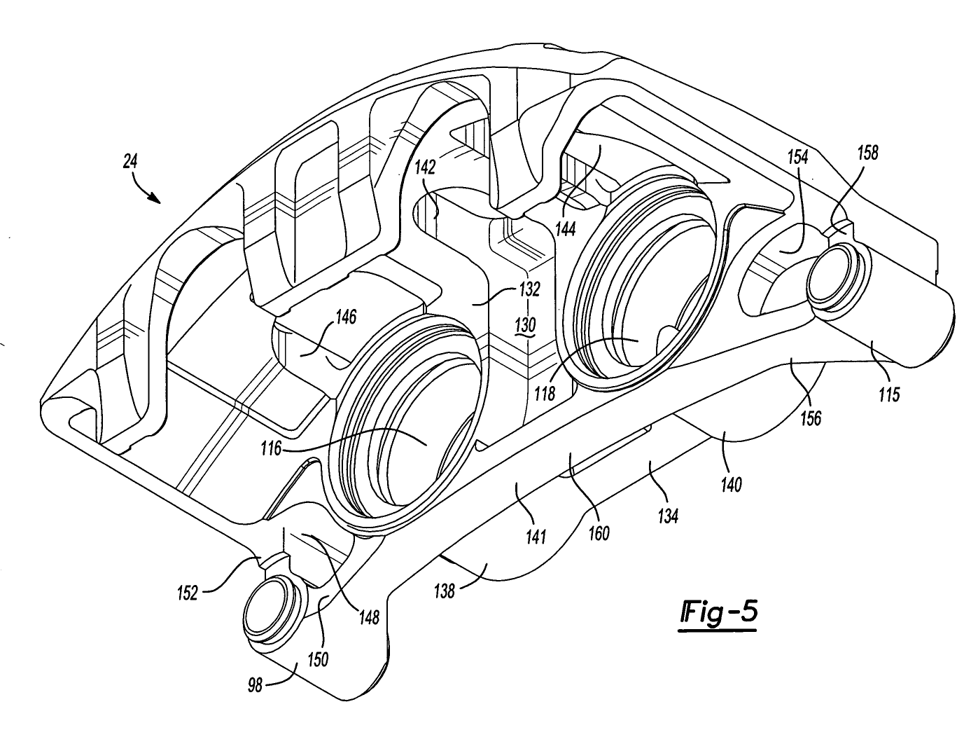

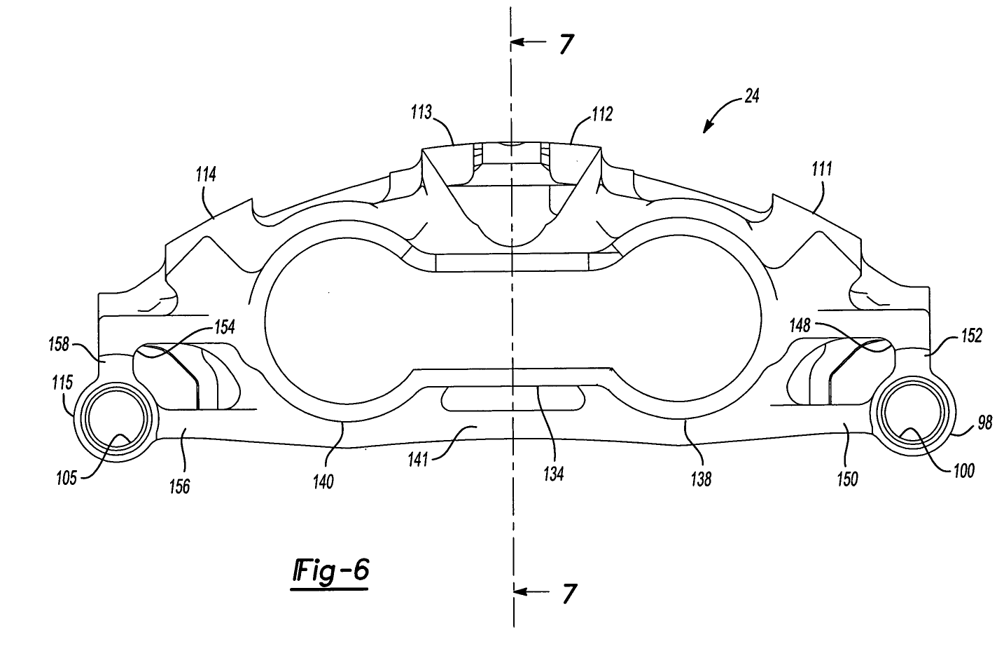

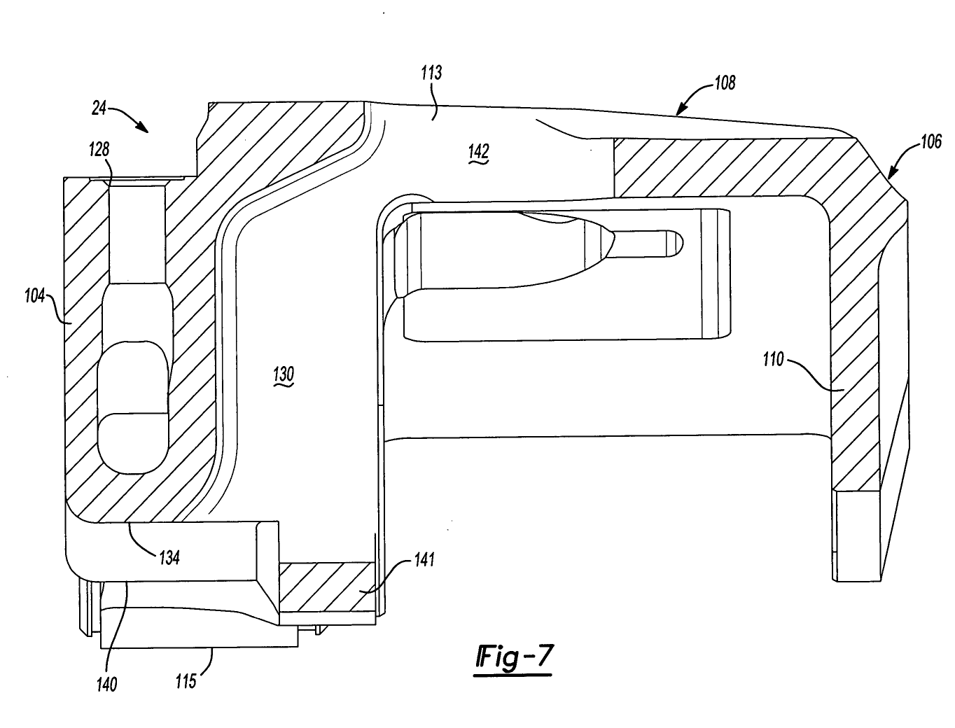

With reference to FIGS. 1-7, a disc brake constructed in accordance with the teachings of the present invention is identified at reference numeral 10. Disc brake 10 is operable to selectively clamp an inboard brake shoe 12 and an outboard brake shoe 14 against a rotatable disc 16 to decelerate a vehicle (not shown). Disc brake 10 includes a support bracket 18 adapted to mount to a steering knuckle or axle component of the vehicle to support disc brake during operation. A first slide pin 20 and a second slide pin 22 are mounted to support bracket 18. First slide pin 20 and second slide pin 22 laterally inwardly protrude from support bracket 18. A caliper 24 is slidably supported on first slide pin 20 and second slide pin 22. A first piston 26 and a second piston 28 are moveably supported within caliper 24. Hydraulic pressure is selectively supplied to caliper 24 to translate first piston 26 and second piston 28. Inboard brake shoe 12 and outboard brake shoe 14 are positioned on opposite wear surfaces of disc 16. Caliper 24 at least partially envelops inboard brake shoe 12 and outboard brake shoe 14 such that axial movement of first piston 26 and second piston 28 cause the brake shoes to clamp on disc 16.

Brake support bracket 18 is a one-piece frame-shaped member preferably constructed by a casting or forging process. Support bracket 18 includes a first leg 30, a second leg 32, a third leg 34 and a fourth leg 36. First leg 30 is a substantially linear elongated member positioned substantially parallel to second leg 32. Second leg 32 is arched in a radial direction in relation to a laterally extending axis 38 about which disc 16 rotates. One end of first leg 30 is interconnected to one end of second leg 32 via third leg 34. The opposite ends of legs 30 and 32 are interconnected by fourth leg 36. First leg 30 includes a first detent 40 and a second detent 42.

Inboard brake shoe 12 includes a lining block 43 mounted on a backing plate 44. Backing plate 44 includes integrally formed tabs 46 and 48 protruding from each end. Detents 40 and 42 restrict inboard brake shoe 12 from radial movement but allow lateral movement of the brake shoe. Clips 50 may be inserted within detents 40 and 42 to assist in maintaining the proper position of inboard brake shoe 12 during operation. Second leg 32 includes a similar pair of detents 52 and 54. Outboard brake shoe 14 includes a lining block 55 mounted to a backing plate 56. Backing plate 56 includes integrally formed tabs 58 and 60 protruding from each end. Clips 62 cooperate with detents 52 and 54 to restrain tabs 58 and 60 from linear movement while allowing lateral movement parallel to axis 38.

First leg 30 includes a pair of brake mounting apertures 64 operable to receive brake fasteners to couple support bracket 18 to a knuckle or other vehicle suspension component (not shown). Caliper 24, inboard brake shoe 12 and outboard brake shoe 14 are supported via this structural interconnection. Support bracket 18 also includes a first slide pin aperture 66 and a second slide pin aperture 68. Slide pin aperture 66 extends laterally through first leg 30 along a first slide pin axis 69. Slide pin 20 is threadingly engaged with pin aperture 66 and protrudes laterally inboard along axis 69. A bushing 80 is coupled to first slide pin 20 to isolate the slide pin from the caliper and reduce caliper rattle on the slide pins. An axially collapsible bellows 92 has a first end 94 coupled to first slide pin 20. A second end 96 of bellows 92 is secured to a boss portion 98 formed on caliper 24. Second slide pin 22 is threadingly engaged with support bracket 18 and positioned within second slide pin aperture 68. Another bellows 92 is coupled to second slide pin 22.

Caliper 24 includes a pin bore 100 in receipt of first slide pin 20. A running-class fit exists between first slide pin 20 and pin bore 100 to allow caliper 24 to translate laterally relatively to support bracket 18 during operation. Bellows 92 is operable to axially extend and compress to account for the relative movement between caliper 24 and support bracket 18. A cap 102 engages boss portion 98 and covers pin bore 100. Cap 102 is removable to allow access to a drive recess 103 should brake service and removal of first slide pin 20 be required. Similarly, caliper 24 includes a second pin bore 105 in receipt of second slide pin 22. A slip-fit also exists between second slide pin 22 and second pin bore 105 to allow caliper 24 to translate relative to support bracket 18 along a second slide pin axis 107.

Caliper 24 is a generally “C” shaped member having an inboard side portion or rail 104 and an outboard side portion 106 interconnected by a laterally extending bridge 108. Outboard side portion 106 includes a plurality of spaced apart fingers 110 positioned opposite rail 104. Bridge 108 includes four substantially parallel bridge portions 111, 112, 113 and 114 spaced apart from one another. Rail 104 includes a boss portion 98 as well as another boss portion 115 positioned at opposite ends of rail 104. Furthermore, rail 104 includes a first piston bore 116 spaced apart from a second piston bore 118. First piston 26 is slidably positioned within first piston bore 116 to move along a first piston bore axis 120. A first piston boot 122 sealingly engages first piston 26 and rail 104 to protect the piston bore from ingress of contamination. Similarly, second piston 28 is slidably positioned within second piston bore 118 to move along a second piston bore axis 124. A second piston boot 126 sealingly engages second piston 28 and rail 104. First piston 26 and second piston 28 are operable under hydraulic fluid pressure entering a port 128 to apply a force to backing plate 44 of inboard brake shoe 12.

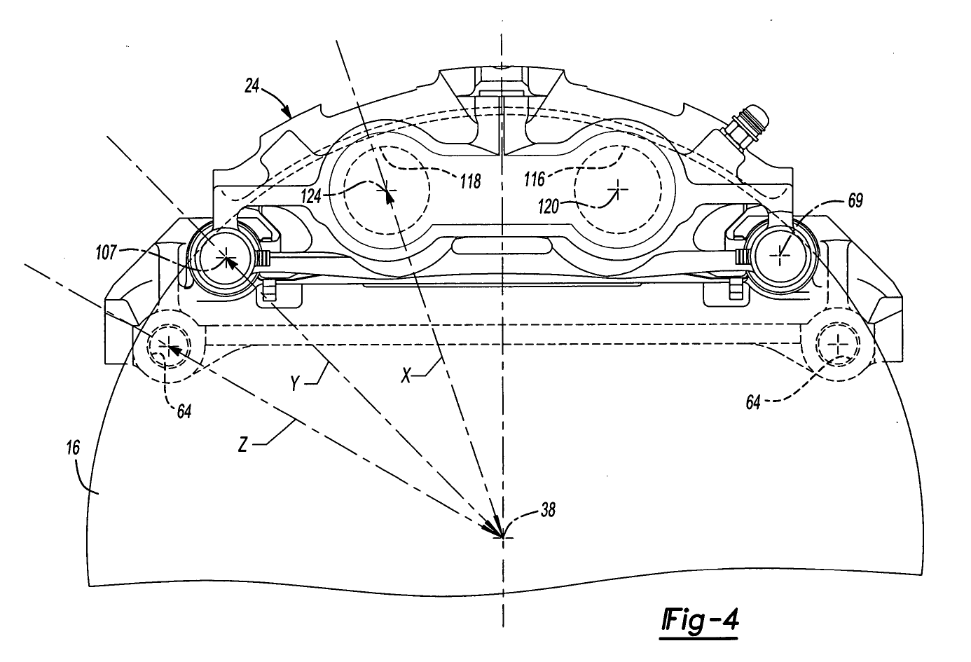

With reference to FIG. 4, it should be appreciated that first piston bore axis 120 and second piston bore axis 124 are positioned at a first radial distance X from laterally extending axis 38. First slide pin axis 69 and second slide pin axis 107 are positioned at a radial distance Y from disc axis of rotation 38. Distance Y is greater than distance X such that piston bores 116 and 118 are radially inward of slide pin apertures 66 and 68. The centerline of brake mounting apertures 64 are radially positioned from axis 38 a distance Z. Distance Y and distance Z are substantially equivalent to one another. It should also be noted that each of the piston bore axes, the slide pin bore axes and the centerlines of brake mounting apertures 64 are radially positioned within the circumference of disc 16. This positioning provides a reduced brake envelope to assist in packaging the brake in a vehicle. Also, the arrangement provides a well balanced caliper for long term use.

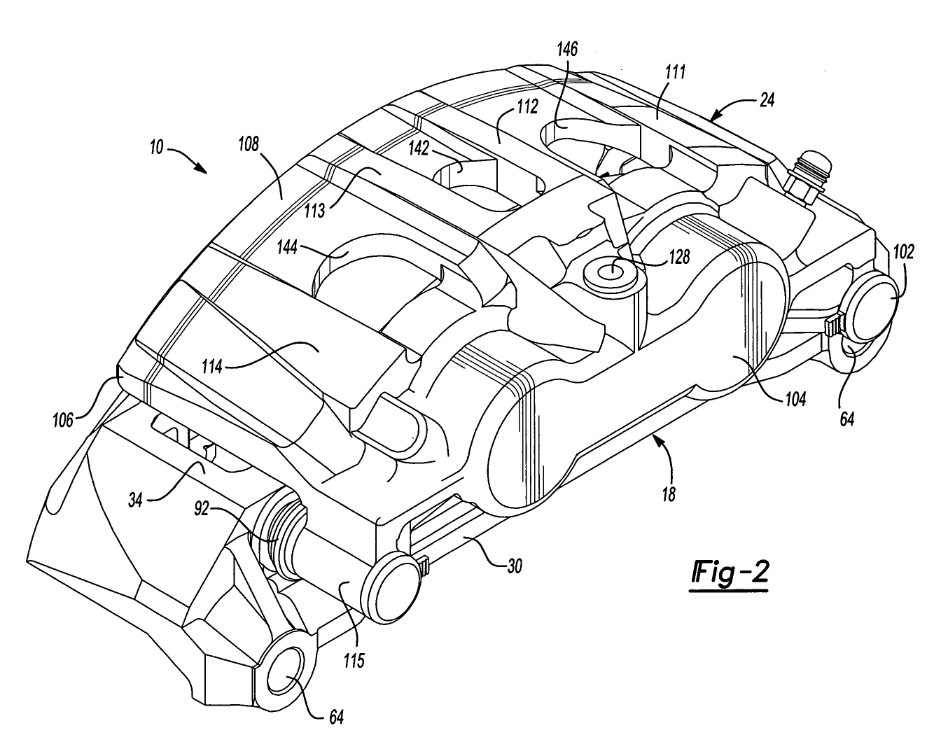

As best shown in FIGS. 2 and 5-7, caliper 24 includes a number of weight-saving features combined with one another. Subsequent embodiments including one or more of the weight-reducing features will be described hereinafter. One skilled in the art will appreciate that embodiments including singular features or combinations of the weight-reducing features are contemplated as being within the scope of the appended claims.

Caliper 24 includes a recess 130 laterally inwardly extending from a surface 132 formed on rail 104. To achieve substantial weight savings it may be desirable to construct recess 130 With a depth of at least one-half the thickness of rail 104. Recess 130 extends approximately three-quarters of the way through rail 104. Recess 130 extends through a bottom surface 134 of rail 104 and separates a first cylindrical portion 138 defining first piston bore 116 from a second cylindrical portion 140 defining second piston bore 118. A web 141 interconnects first cylindrical portion 138 and second cylindrical portion 140.

Bridge portions 112 and 113 define at least a portion of a window 142 extending through bridge 108. Recess 130 is in communication with window 142. An opening 144 is bounded by bridge portions 113 and 114. Another opening 146 is substantially similar to opening 144 and is bounded by bridge portions 111 and 112. Window 142, as well as openings 144 and 146, reduce the mass of caliper 24 and provide a visual path for a user to inspect brake shoes 12 and 14.

To further reduce the weight of caliper 24, a second window 148 extends through rail 104 adjacent boss portion 98. A first web 150 interconnects boss portion 98 and first cylindrical portion 138 of first piston bore 116. A second web 152 interconnects boss portion 98 with another portion of rail 104. A third window 154 extends through rail 104 adjacent boss portion 115. Webs 156 and 158 at least partially define window 154 and interconnect boss portion 115 with the remainder of rail 104. Webs 141, 150 and 156 share a common uninterrupted surface 160.

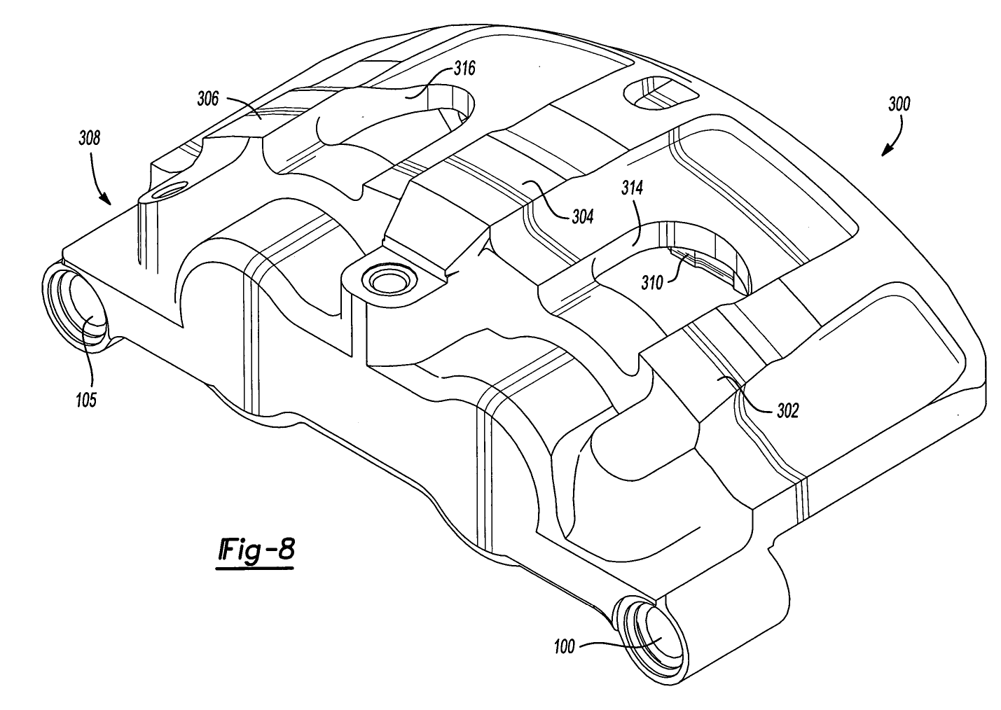

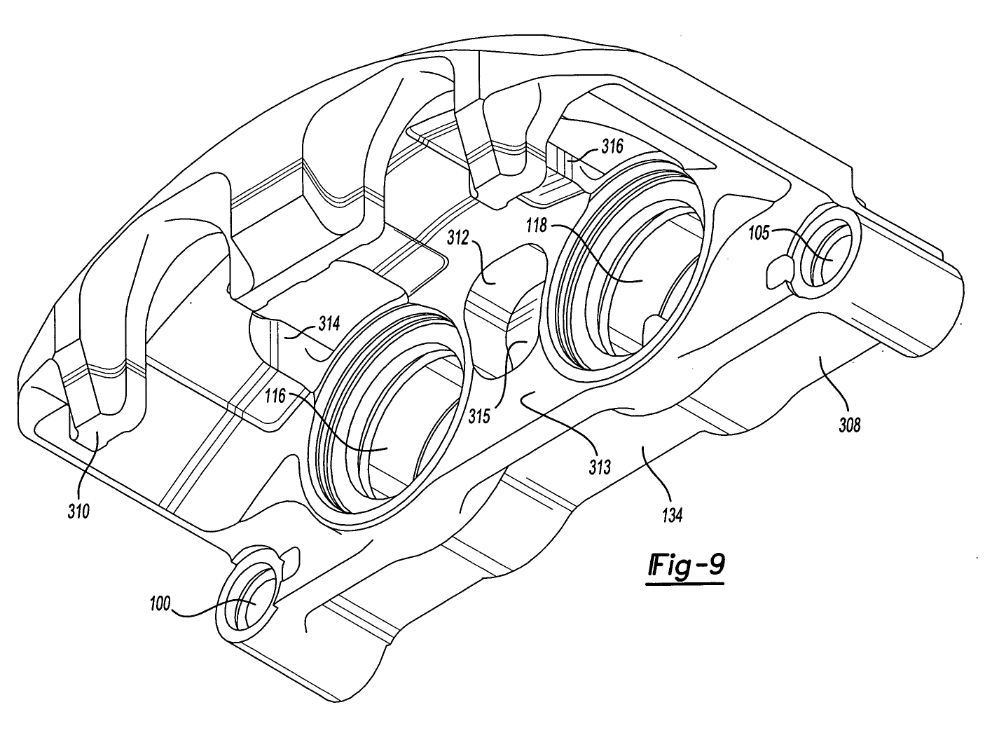

Referring to FIGS. 8-9, an alternate embodiment disc brake caliper is depicted at reference number 300. Disc brake caliper 300 is substantially similar to caliper 24 except that caliper 300 includes fewer weight-saving features. Because caliper 300 is substantially similar to caliper 24, like elements will retain their previously introduced reference numerals. Caliper 300 includes three bridge portions, 302, 304 and 306 interconnecting a rail 308 and fingers 310. A blind pocket 312 inwardly extends from a surface 313 a distance greater than one-half the thickness of rail 308. Pocket 312 terminates at a bottom surface 315. Pocket 312 is positioned between first piston bore 116 and second piston bore 118. Pocket 312 does not extend beyond surface 134.

A window 314 is partially defined by bridge portion 302 and bridge portion 304. Similarly, a second window 316 is at least partially defined by bridge portion 304 and bridge portion 306. As such, it should be appreciated that caliper 300 incorporates some but not all of the mass-reducing features described in relation to caliper 24.

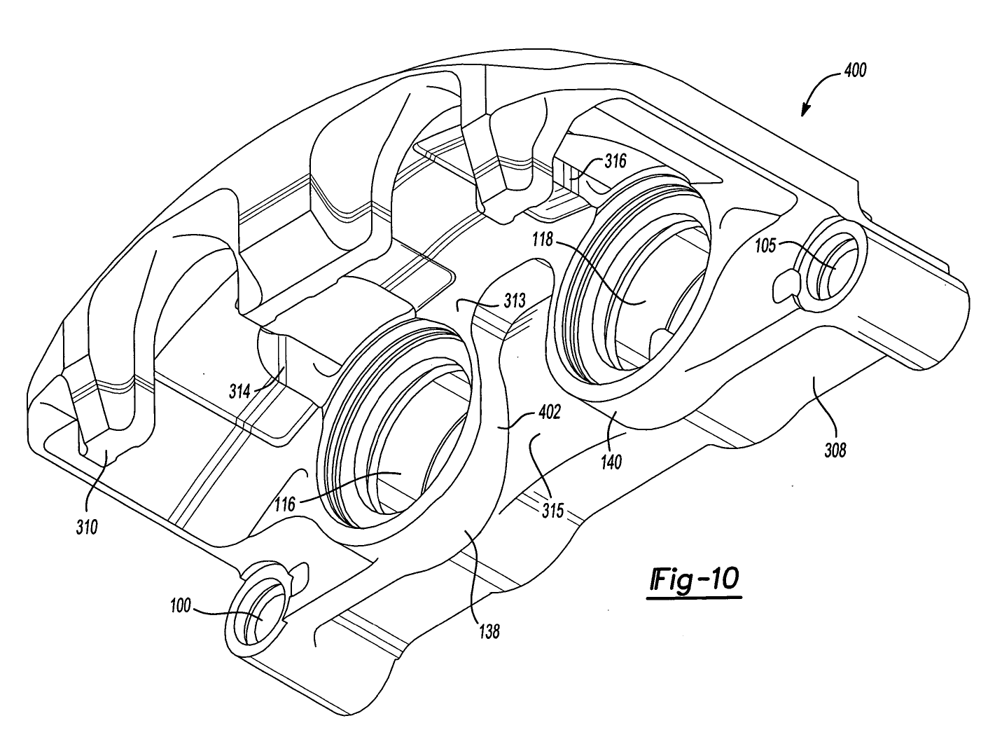

FIG. 10 depicts another alternate embodiment caliper 400. Caliper 400 is substantially similar to caliper 300 with the exception that pocket 312 is replaced with an elongated slot 402. Slot 402 transversely extends into rail 308 as previously described in relation to pocket 312. Slot 402 radially extends through the bottom of rail 308 to separate first cylindrical portion 138 from second cylindrical portion 140. As is evident from the figures, embodiment 400 provides greater mass-reduction than embodiment 300.

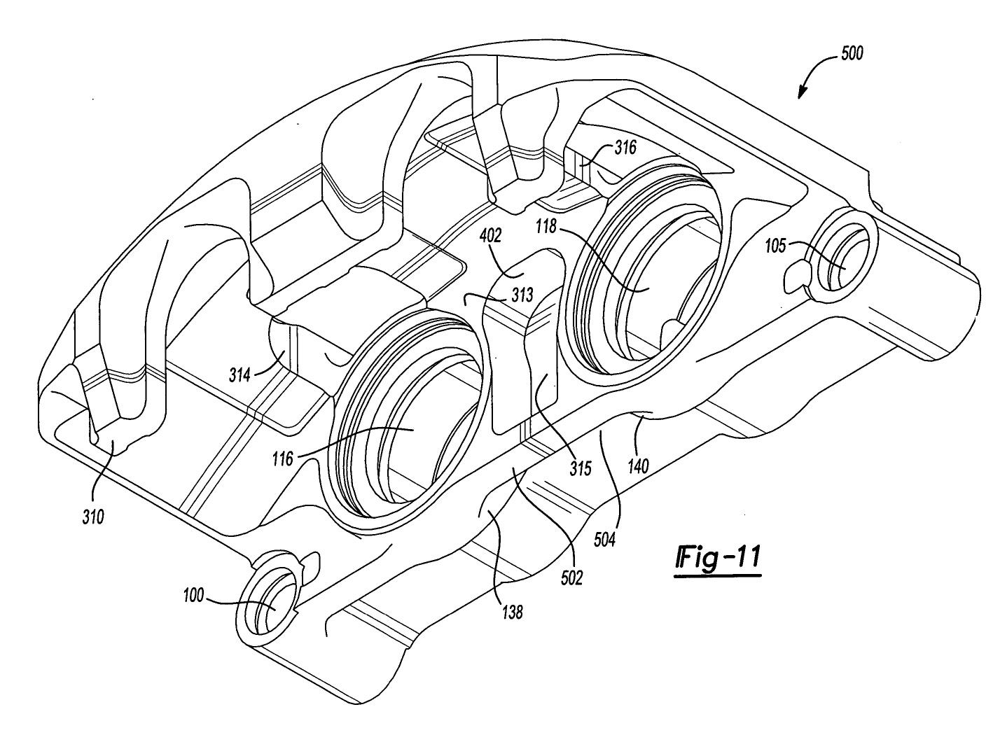

FIG. 11 depicts another alternate embodiment disc brake caliper identified at reference numeral 500. Caliper 500 is substantially similar to caliper 400 except that a web of material 502 has been added at the bottom of slot 402 to interconnect a portion of first cylindrical portion 138 with second cylindrical portion 140. The addition of web 502 may be beneficial to maintain the position and parallel alignment of first piston bore 116 and second piston bore 118 during operation. It should be appreciated that web 502 does not completely close slot 402 but simply traverses it. Slot 402 terminates at an opening 504.

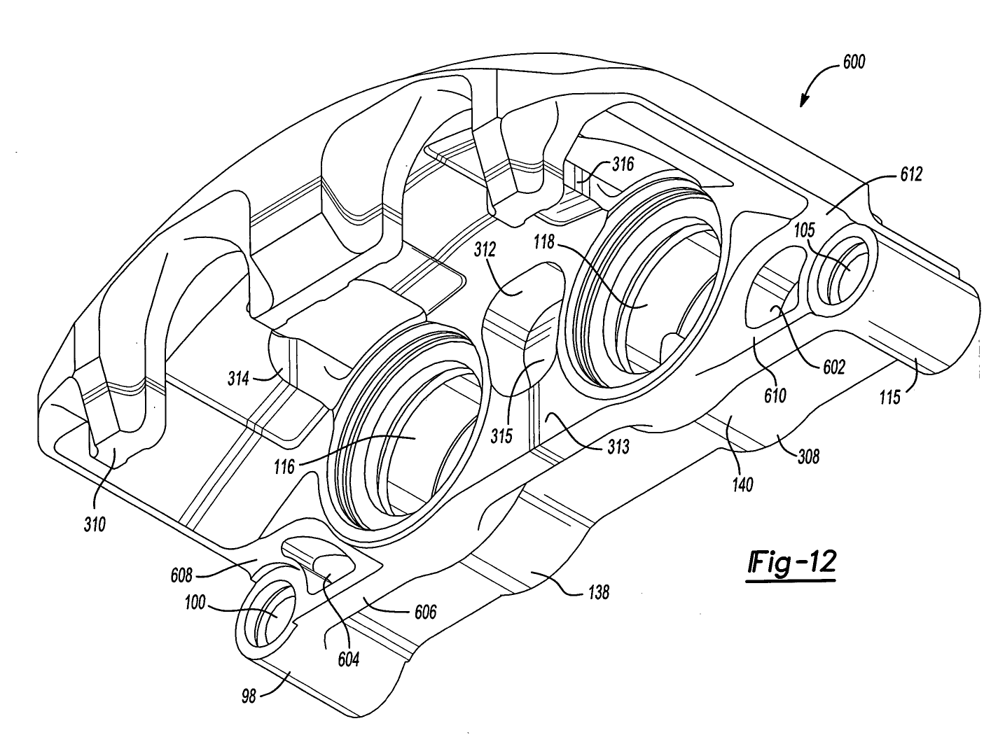

FIG. 12 depicts another alternate embodiment disc brake caliper 600. Caliper 600 is substantially similar to caliper 300. As such, like elements will retain their previously introduced reference numerals. Caliper 600 includes a first window 602 and a second window 604 extending through rail 308. Window 604 is positioned between boss portion 98 and first piston bore 116. A web 606 interconnects boss portion 98 and first cylindrical portion 138 of first piston bore 116. Another web 608 connects boss portion 98 with a portion of rail 308. Window 602 is similarly defined by a web 610 and a web 612. Embodiment 600 illustrates that any number of the features previously described in relation to the other embodiments may be combined with one another to provide a distinct embodiment. As mentioned earlier, it should be understood that the claims are not to be limited by any one of the depicted embodiments, but that any number of feature combinations may occur.

Furthermore, the foregoing discussion discloses and describes merely exemplary embodiments of the present invention. One skilled in the art will readily recognize from such discussion, and from the accompanying drawings and claims, that various changes, modifications and variations may be made therein without department from the spirit and scope of the invention as defined in the following claims.

What is claimed is:

1. A disc brake operable to apply a clamping force to a rotatable disc, the disc brake comprising:
a support bracket;
slide pins coupled to said support bracket;
inner and outer brake shoes; and
a caliper slidably supported by the slide pins, the caliper having first and second spaced apart piston cavities positioned along a longitudinally extending rail, a plurality of spaced apart fingers positioned opposite said rail and a laterally extending bridge interconnecting said rail and said fingers, said bridge including four spaced apart and substantially parallel bridge portions.

2. The disc brake of claim 1 wherein said caliper includes two bosses formed at opposite ends of said rail, said bosses in receipt of said slide pins.

3. The disc brake of claim 2 wherein said caliper includes a first window extending through said rail adjacent to one of said bosses.

4. The disc brake of claim 3 wherein said first window is at least partially bounded by first and second webs, each web interconnecting said one of said bosses with a portion of said rail including said piston cavities.

5. The disc brake of claim 4 wherein said rail includes a recess laterally extending from a side of said rail including openings to said piston cavities.

6. The disc brake of claim 5 wherein said recess is longitudinally positioned between said piston cavities.

7. The disc brake of claim 6 wherein two of said bridge portions define an aperture extending through said bridge, said aperture being longitudinally positioned between said piston cavities.

8. The disc brake of claim 7 wherein said rail recess is in communication with said aperture extending through said bridge.

9. The disc brake of claim 8 wherein said caliper includes a second window extending through said rail, said second window being longitudinally positioned between said piston cavities.

10. The disc brake of claim 9 wherein said second window is in communication with said recess.

11. The disc brake of claim 10 wherein said second window is defined by a third web interconnecting said piston cavities.

12. The disc brake of claim 6 wherein said caliper includes a third web traversing said rail recess and interconnecting said piston cavities.

13. A disc brake operable to apply a clamping force to a rotatable disc, the disc brake comprising:
a support bracket;
slide pins coupled to said support bracket;
inner and outer brake shoes; and
a caliper slidably supported by the slide pins, the caliper having first and second spaced apart blind piston cavities positioned along a longitudinally extending rail, a plurality of spaced apart fingers positioned opposite said rail and a laterally extending bridge interconnecting said rail and said fingers, said bridge including spaced apart and substantially parallel bridge portions, said rail including a recess extending inwardly from a side of said rail including openings to said blind piston cavities.

14. The disc brake of claim 13 wherein said recess is longitudinally positioned between said piston cavities.

15. The disc brake of claim 14 wherein said recess extends through a bottom wall of said rail to separate portions of said rail defining said piston cavities.

16. The disc brake of claim 15 wherein said caliper includes a web traversing said rail recess and interconnecting said piston cavities.

17. The disc brake of claim 16 wherein said caliper includes two bosses formed at opposite ends of said rail, said bosses in receipt of said slide pins.

18. The disc brake of claim 17 wherein said caliper includes a second window extending through said rail adjacent to one of said bosses.

19. The disc brake of claim 18 wherein two of said bridge portions define an aperture extending through said bridge, said aperture being longitudinally positioned between said piston cavities.

20. The disc brake of claim 19 wherein said rail recess is in communication with said aperture extending through said bridge.

21. The disc brake of claim 13 wherein said recess extends into said rail a depth greater than one-half of a thickness of said rail.

22. A disc brake comprising:
a rotatable disc;
a support bracket;
slide pins coupled to the support bracket, each slide pin extending along a pin axis aligned to intersect the disc;
inner and outer brake shoes; and
a caliper slidably supported by the slide pins, the caliper slidably supporting two pistons operable to cause the inner and outer brake shoes to move toward the rotatable disc, the caliper including a rail having cavities in receipt of said pistons and a recess positioned between said piston cavities.

23. The disc brake of claim 22 wherein said recess extends through a bottom wall of said rail to separate portions of said rail defining said piston cavities.

24. The disc brake of claim 23 wherein said caliper includes a web traversing said rail recess and interconnecting said piston cavities.

25. The disc brake of claim 22 wherein said caliper includes two bosses formed at opposite ends of said rail, said bosses in receipt of said slide pins.

26. The disc brake of claim 25 wherein said caliper includes a window extending through said rail adjacent to one of said bosses.
